(19) United States
(12) Patent Application Publication
(10) Pub. No.: US 2008/0282055 A1
(43) Pub. Date: Nov. 13, 2008

(54) Virtual Translation Lookaside Buffer

(76) Inventor: Rongzhen Yang, Shanghai (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 10/577,630

(22) PCT Filed: Dec. 29, 2005
(86) PCT No.: PCT/CN05/02366

§ 371 Date: Apr. 28, 2006

(51) Int. Cl. G06F 12/10

(52) U.S. Cl. 711/207; 711/E12.061

(57) ABSTRACT

A virtual page number lookup request is received at a virtual Translation Lookaside Buffer (TLB), wherein the virtual TLB includes an instruction TLB and a data TLB. A lookup of the virtual page number in the virtual TLB is performed. A physical page number corresponding to the virtual page number in the virtual TLB is returned.

### TECHNICAL FIELD

Embodiments of the invention relate to the field of computer systems and more specifically, but not exclusively, to a virtual translation lookaside buffer.

### BACKGROUND

Modern computer systems utilize virtual memory. Virtual memory allows the memory address space of a computer system to be greater than the physical memory space available. Portions of programs and data currently in use may be kept in memory, while unused portions are stored on a disk until needed.

The relationship of virtual addresses to physical addresses may be managed using page tables. Page tables are used to manipulate memory in units of pages. The translation between virtual addresses and physical addresses may be conducted by a Memory Management Unit (MMU).

The MMU may use a Translation Lookaside Buffer (TLB) that stores address information regarding the most recently accessed pages. The TLB may speed up execution time because the MMU can more quickly obtain address information from the TLB than page tables. However, in today's memory designs, a TLB miss slows the performance of computer systems.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a computer system including a virtual TLB in accordance with an embodiment of the invention.

FIG. 2 is a diagram illustrating compiling a bytecode method in accordance with an embodiment of the invention.

FIG. 3 is a diagram illustrating executing a compiled bytecode method in accordance with an embodiment of the invention.

FIG. 4 is a diagram illustrating executing a compiled bytecode method in accordance with an embodiment of the invention.

FIG. 5 is a flowchart illustrating the logic and operations of a virtual TLB in accordance with an embodiment of the invention.

FIG. 6 is a diagram illustrating a virtual TLB in accordance with an embodiment of the invention.

FIG. 7 is a diagram illustrating a virtual TLB in accordance with an embodiment of the invention.

FIG. 8 illustrates embodiments of a computer system for implementing embodiments of the invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following description and claims, the term “coupled” and its derivatives may be used. “Coupled” may mean that two or more elements are in direct contact (physically, electrically, magnetically, optically, etc.). “Coupled” may also mean two or more elements are not in direct contact with each other, but still cooperate or interact with each other.

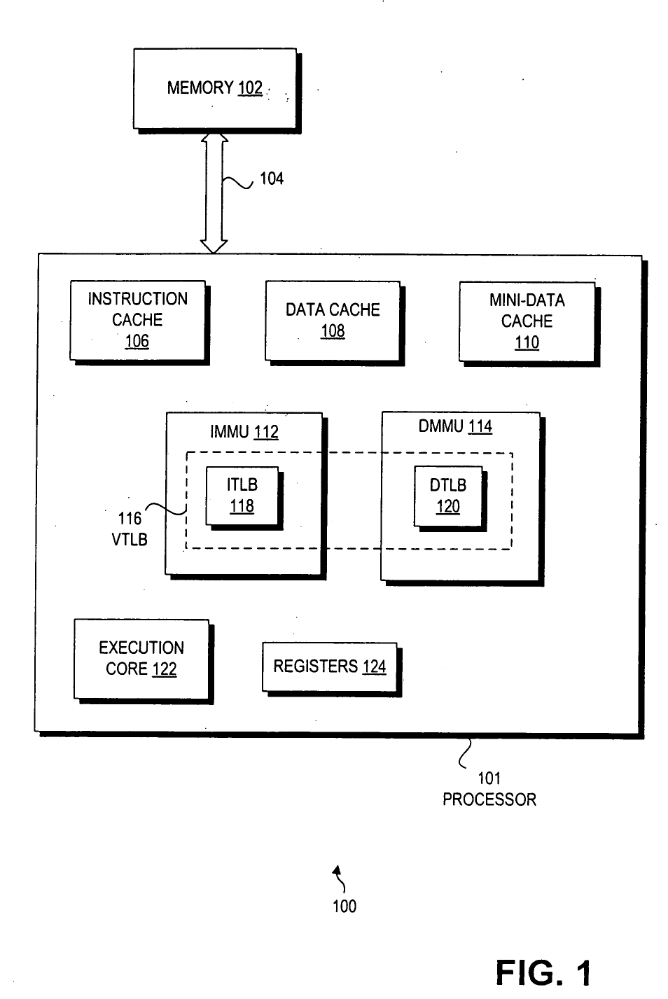

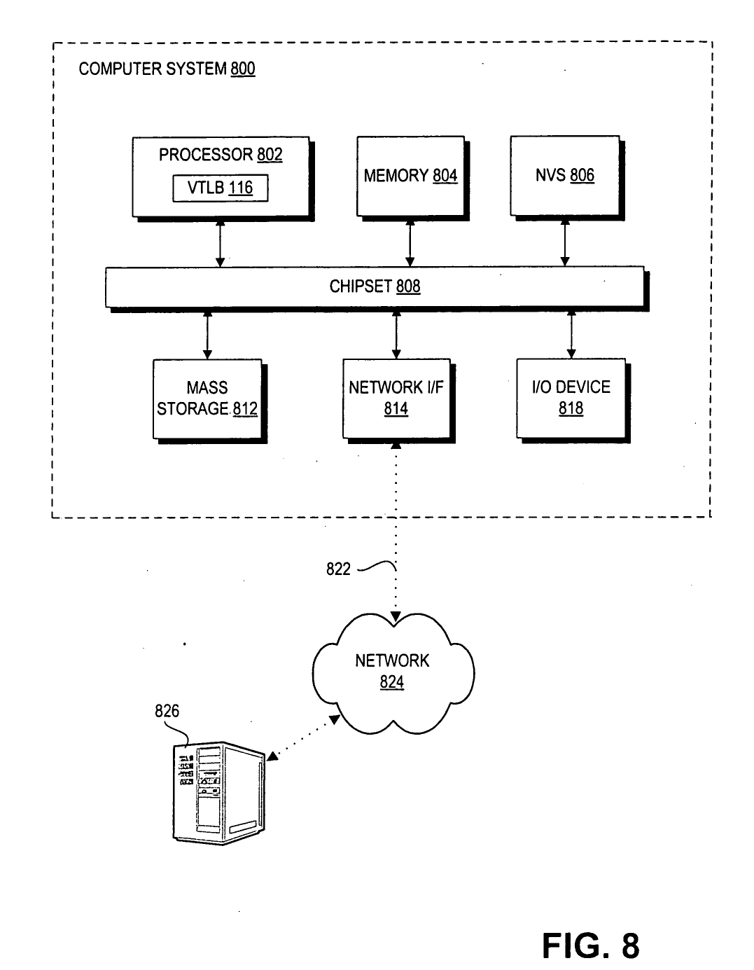

Turning to FIG. 1, a computer system 100 in accordance with an embodiment of the invention is shown. Computer system 100 includes a processor 101 coupled to memory 102 by a bus 104. Embodiments of computer system 100 may include a mobile device, such as a mobile phone, a personal digital assistant, a media player, or other similar device with on board processing power and wireless communications ability that is powered by a battery. Further embodiments of a computer system are described below in conjunction with FIG. 8.

In one embodiment, processor 101 may be compliant with an Intel® XScale™ core architecture. While embodiments of the invention are described herein in relation to an Xscale™ core, it will be understood that embodiments herein may be implemented in various processor designs. Components of processor 101 described below may be coupled together by one or more busses (not shown). Other components of processor 101, such as buffers, a power management controller, a debug unit, and so on, are not shown for the sake of clarity.

Processor 101 includes an instruction cache 106 for storing local copies of instructions. Processor 101 includes a data cache 108 for storing local copies of data and a mini-data cache 110 to avoid thrashing of data cache 108 for frequently changing data.

Processor 101 may include an execution core 122 for executing instructions. An instruction may include a microinstruction, or the like. In one embodiment, processor 101 may execute instructions in compliance with an Advanced RISC (Reduced Instruction Set Computer) Machines (ARM®) instruction set, including Thumb (T) or Long Multiply (M) variants. In one embodiment, processor 101 includes an Intel® XScale™ core architecture that may execute an ARM® instruction set version 5TE. Processor 101 may include registers 124 for holding instructions and/or data.

Processor 101 may include an Instruction Memory Management Unit (IMMU) 112 having an Instruction TLB (TLB) 118. A Data Memory Management Unit (DMMU) 114 may include a Data TLB (DTLB) 120. In one embodiment, IMMU 112 is used in address translation for instruction accesses, while DMMU 114 is used in address translation of data accesses. As used herein, the term “access” may include a read or a write.

In one embodiment, ITLB 118 and DTLB 120 may be structured to operate as a Virtual TLB (VTLB) 116. Embodiments herein provide for looking up address information in ITLB 118 and DTLB 120 simultaneously in order to reduce TLB misses and consequently increase system performance.

When an MMU, such as IMMU 112 or DMMU 114, receives a virtual address for translation, the MMU may first look to the Virtual TLB 116 for determining the corresponding physical address. The MMU may receive a translation request in response to a memory access request. In one embodiment, IMMU 112 and DMMU 114 share access to Virtual TLB 116.

If the Virtual TLB 116 does not contain the necessary page information for translation (referred to as a TLB miss), then the MMU may initiate a page table lookup. A page table lookup uses one or more page tables to determine the physical address corresponding to a virtual address. If a TLB miss occurs, information from the page table(s) may be used to update virtual TLB 116 so that virtual TLB 116 maintains information regarding the most recently accessed pages. In one embodiment, at least a portion of one or more page tables are stored in memory 102. The remaining page table portions (if any) may be stored locally, such as on a hard disk drive.

In one embodiment, a virtual address includes a virtual page number and an offset. The offset is used to identify a specific address with the virtual page. Virtual TLB 116 may store a physical page number that corresponds to a given virtual page number. In one embodiment, a virtual page and a physical page are the same size, such as, but not limited to, 512 bytes, 4 kilobytes (KB), 64 KB, or the like. An MMU may combine the offset (provided in the virtual address) with the base address of the physical page number to determine the physical address.

For example, a virtual address 8020 may include virtual page number 1 (having a base address of 8000) and offset 20. The virtual page number may translate to physical page 5 (having a base address of 10000). Thus, the physical address translates to 10020 (base address 10000+offset 20).

In other embodiments, TLB entries may hold other information such as a page modification field to indicate if the page has been modified, a valid field to indicate if the page is in use, a protection field to indicate read/write settings of the page, a process identification field to indicate a process associated with the page, or the like.

Embodiments of the invention may reduce TLB misses and improve performance of a Managed Runtime Environment (MRTE). A Managed Runtime Environment (MRTE) is increasingly important in mobile embedded systems, such as mobile devices. At the same time, running a MRTE on a mobile processor may create a performance bottleneck at the mobile processor.

MRTEs dynamically load and execute code. The code and other related data may be loaded from class files. Each class file may describe a single class that includes class variables and class methods. In one embodiment, a class variable defines a data type, while a class method defines a function.

An MRTE allows application programs to be built that could be run on any platform without having to be rewritten or recompiled for each specific platform. MRTE code may be compiled to produce bytecode. Bytecode is machine-independent code. At execution, the bytecode is converted into machine code for a targeted platform by a Just-In-Time (JIT) compiler executing on the end user's platform. The platform's processor may then execute the compiled bytecode. The JIT compiler is aware of the specific instructions and other particularities of the platform processor.

A common MRTE is the Java™ language run in a Java Virtual Machine (JVM™). In one embodiment, computer system 100 may run Java 2 Platform, MicroEdition (J2ME™).

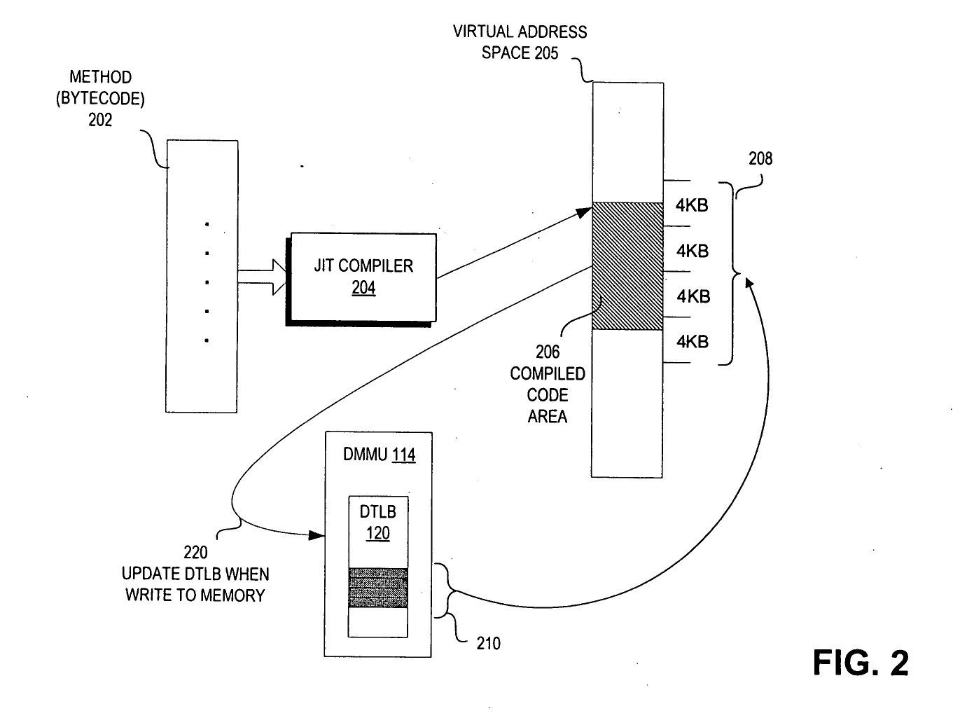

Two aspects of a Java Virtual Machine running on an Intel® Xscale™ platform may result in TLB misses: hot spot implementations and literals implementation. These aspects are discussed below in conjunction with FIGS. 2-4.

Turning to FIG. 2, a method 202 in bytecode is compiled by a JIT compiler 204. The compiled bytecode is stored into virtual address space 205 at compiled code area 206. In one embodiment, method 202 includes a Java™ method and JIT compiler 204 includes a JIT compiler with hot spot optimization, such as a JVM JIT compiler.

Studies have shown that most of a program's time is spent in execution of a small portion of its code called hot spots. JIT compiler 204 may analyze the bytecode to determine where these hot spots are in the code. JIT compiler 204 may then perform optimization techniques on the hot spots instead of wasting time trying to optimize the entire program. Further, the hot spot optimization may continue dynamically as the program executes, so that JIT compiler 204 may adapt optimization techniques to new hot spots.

When method 202 is compiled, the compiled code is written as data to virtual address space 205. Method 202 may have been identified as a hot spot, that is, a “hot” method. Compiled code area 206 is placed into pages 208 of virtual address space 205. In the embodiment of FIG. 2, each page is 4 kilobytes (KB) in size, but other embodiments may use other page sizes. In one embodiment, compiled bytecode is written to compiled code area 206 by using a Store Register (STR) instruction of the ARM instruction set. The STR instruction is used to store a word from a register to a memory address.

Accessing (in this case “writing”) memory results in an update of DTLB 120, as shown at 220. Since pages 208 are written as data, DTLB entries 210 of DTLB 120 are updated with page information corresponding to pages 208. As shown in FIG. 2, each page 208 has a corresponding entry 210 in DTLB 120.

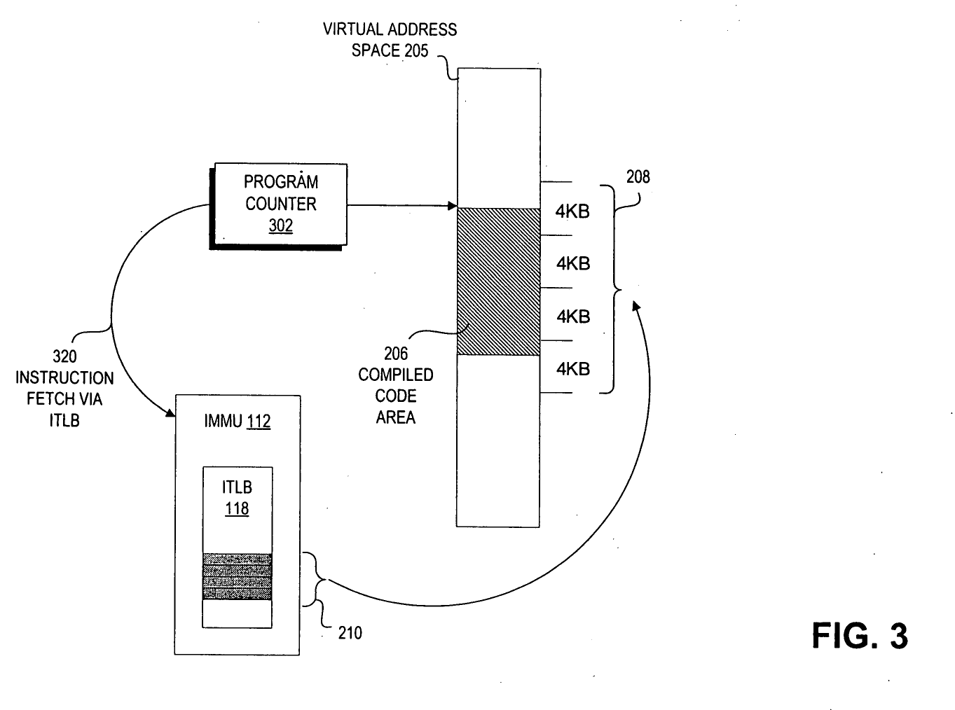

Turning to FIG. 3, when method 202 is to be executed by execution core 122, the complied bytecode (i.e., instructions) corresponding to method 202 are fetched. In one embodiment, a program counter 302 holds the memory address of the next instruction to be executed. The program counter 302 may be a register of processor 100. After the instruction pointed to by program counter 302 is fetched, program counter 302 is updated with the memory address of the next instruction to be fetched.

The instructions are fetched using ITLB 118, as shown at 320. This fetching results in TLB misses, because ITLB 118 initially does not contain the page information for translation. As shown in FIG. 2, the page information was put into DTLB 120 at compile time. When program counter 302 calls on IMMU 112 for address translation during instruction fetching, ITLB 118 does not hold the page information and a TLB miss occurs.

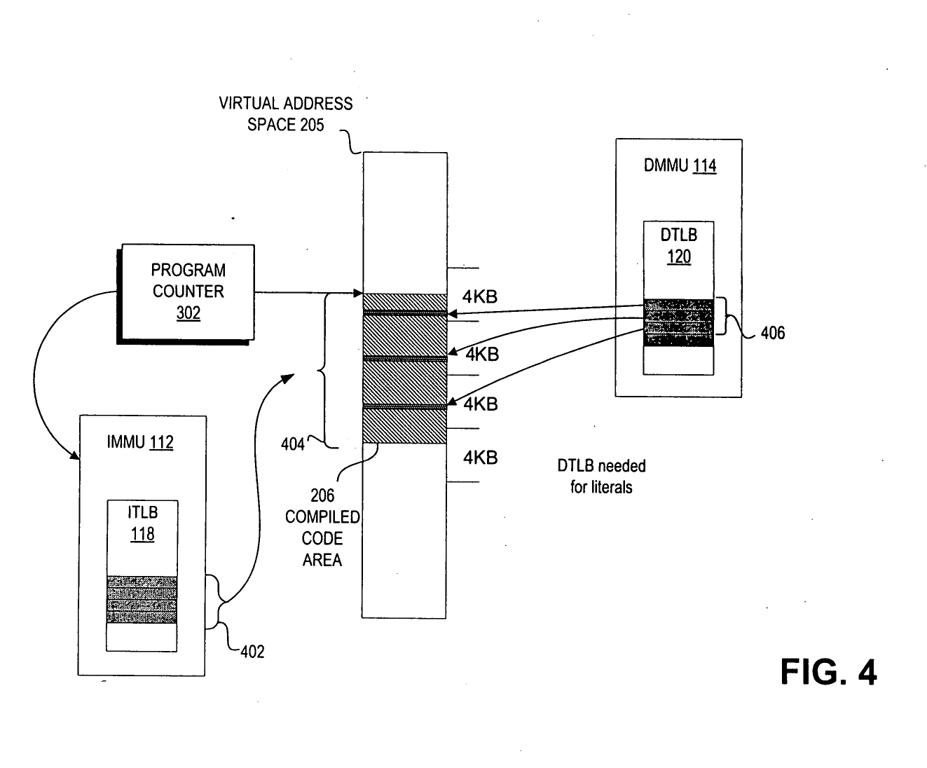

Referring to FIG. 4, the compilation of literals may also lead to TLB misses. In short, a literal includes a constant made available to a method by inclusion in the executable code. Usually, the value of constant is fixed at compile time. When compiled method 202 uses literals, some literals may not be represented directly in Xscale™ instructions. Thus, those literals may be mixed in instructions as data.

In FIG. 4, pages 404 in virtual address space 205 include both data and instructions. ITLB 118 may include page information in entries 402 corresponding to pages 404, and DTLB 120 may include page information in entries 406 corresponding to pages 404 that hold data.

Accessing those literals may use DTLB 120 but the instructions may be accessed using ITLB 118. For example, ARM instruction LDR r1, [r5] is a Load Register instruction to load register r1 with data stored at the address in register r5. Thus, execution of the LDR instruction will invoke an instruction fetch (ITLB 118) and the data address at r5 will invoke a data access (DTLB 120). In this way, the same page uses one DTLB entry and one ITLB entry when running the method. Additional TLB misses may occur when translating virtual addresses for other pages because there are fewer remaining entries in DTLB 120 and ITLB 118 for these other pages.

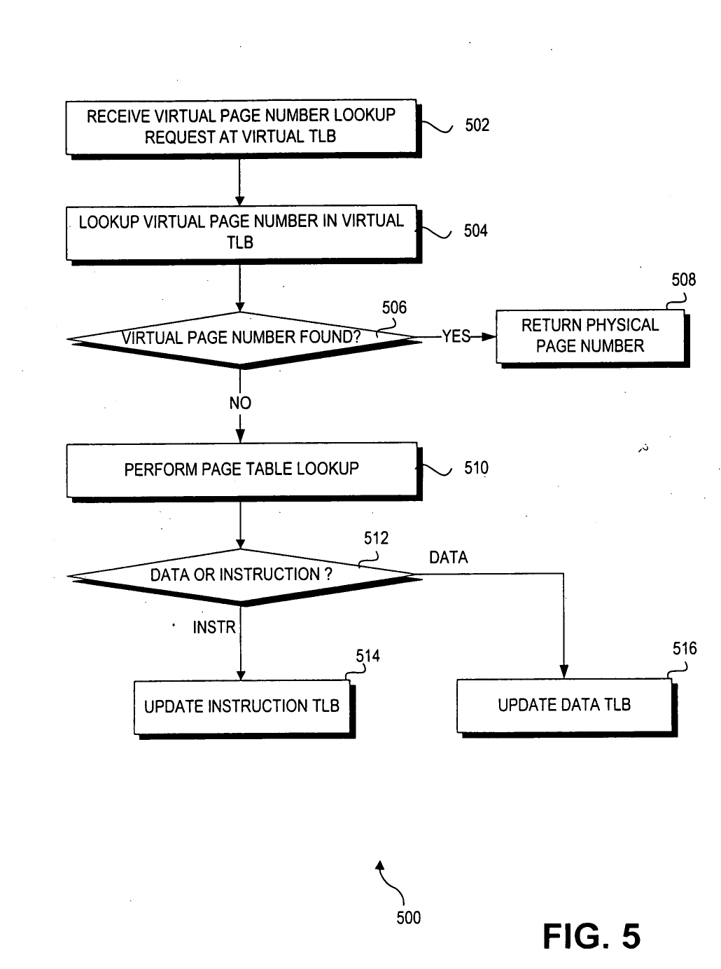

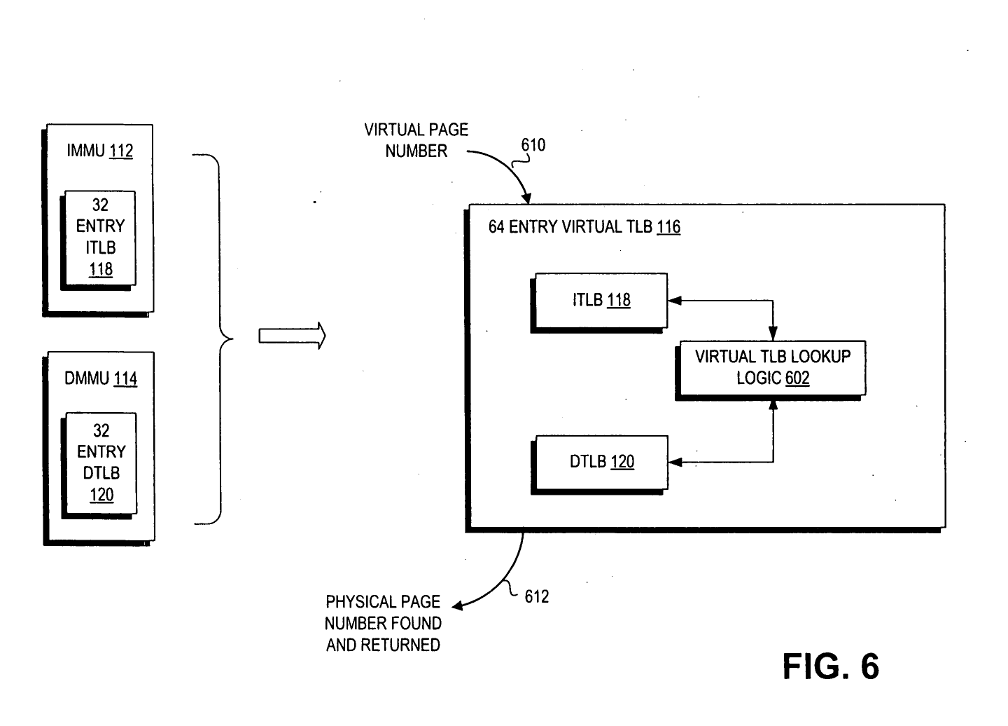

Turning to FIG. 5, a flowchart 500 of an embodiment of the invention is shown. Flowchart 500 may be implemented using software, hardware, or any combination thereof. Flowchart 500 will be discussed in relation to FIG. 6, but it will be understood that flowchart 500 is not limited by the embodiment shown in FIG. 6.

Starting in a block 502, a virtual page number lookup request is received at the virtual TLB. In FIG. 6, a virtual page number is received at virtual TLB 116, as shown at 610. The virtual page number lookup may pertain to an instruction access or a data access.

In the embodiment of FIG. 6, virtual TLB 116 has 64 TLB entries which is a combination of 32 entries of ITLB 118 and 32 entries of DTLB 120. While ITLB 118 and DTLB 120 physically reside in IMMU 112 and DMMU 114, respectively, virtual TLB 116 may be logically considered as a single TLB. Additional logic, shown as virtual TLB lookup logic 602, ties ITLB 118 and DTLB 120 together to enable a TLB lookup to be performed in ITLB 118 and DTLB 120 at the same time. Virtual TLB lookup logic 602 may be implemented as hardware, software, or any combination thereof.

Proceeding to a block 504, a virtual page number lookup is performed in the virtual TLB. In FIG. 6, virtual TLB lookup logic 602 performs the virtual page number lookup in DTLB 120 and ITLB 118. In one embodiment, a virtual page number lookup involves searching the entries in DTLB 120 and ITLB 118 for a virtual page number matching the virtual page number of the received virtual address. If a matching virtual page number is found, then the TLB may provide the corresponding physical page number. The virtual page number lookup is performed in DTLB 120 and ITLB 118 at the same time. In this way, if the virtual address is found in either DTLB 120 or ITLB 118, then a TLB hit occurs.

In FIG. 5, the logic continues to a decision block 506 to determine if the virtual page number was found in virtual TLB 116. If the answer to decision block 506 is yes, then the physical page number is returned. As shown in FIG. 6 at 612, the physical page number may be returned by virtual TLB 116 in the case of a TLB hit. In one embodiment, the MMU (IMMU 112 or DMMU 114) that requested the virtual page number lookup will use the returned physical page number to translate the virtual address to a physical address.

If the answer to decision block 506 is no, then the logic proceeds to a block 510 to perform a page table lookup in one or more page tables. In one embodiment, the page table lookup is performed by an operating system.

Continuing to a decision block 512, the logic determines if the page requested contained data or an instruction(s). If the page held an instruction(s), then the logic continues to a block 514 to update the ITLB. If the page held data, then the logic continues to a block 516 to update the DTLB.

In one embodiment, the logic of decision block 512 determines if the access was to data or to an instruction as follows. If the memory address request came from the program counter register, then the access was to an instruction. In an Intel® XScale™ embodiment, the program counter may be maintained in register 15 (r15).

In the case of a data access, the data access is made by the specific instruction itself, such as LDR or STR. Fields of such instructions that pertain to a data address will reference a register that is not the program counter register. For example, as described above, ARM instruction LDR r1, [r5] is a Load Register instruction to load register r1 with data stored at the address in register r5. The logic will realize that the access is by the instruction itself using a register other than the program counter register, and thus, is a data access.

Updating a TLB may include replacing (such as by writing over) a current entry of the TLB with information from the page table lookup. The TLB stores the virtual page number and corresponding physical page number of the most recently accessed pages. As used herein, an “access” includes a read or a write.

In one embodiment, ITLB 118 and DTLB 120 may be updated using a round-robin algorithm. In one embodiment, the round-robin algorithm maintains a pointer to the next TLB entry to be replaced. The next TLB entry to be replaced is the TLB entry sequentially after the last TLB entry that was written. If the pointer reaches the last TLB entry, the pointer may wrap around to the first TLB entry.

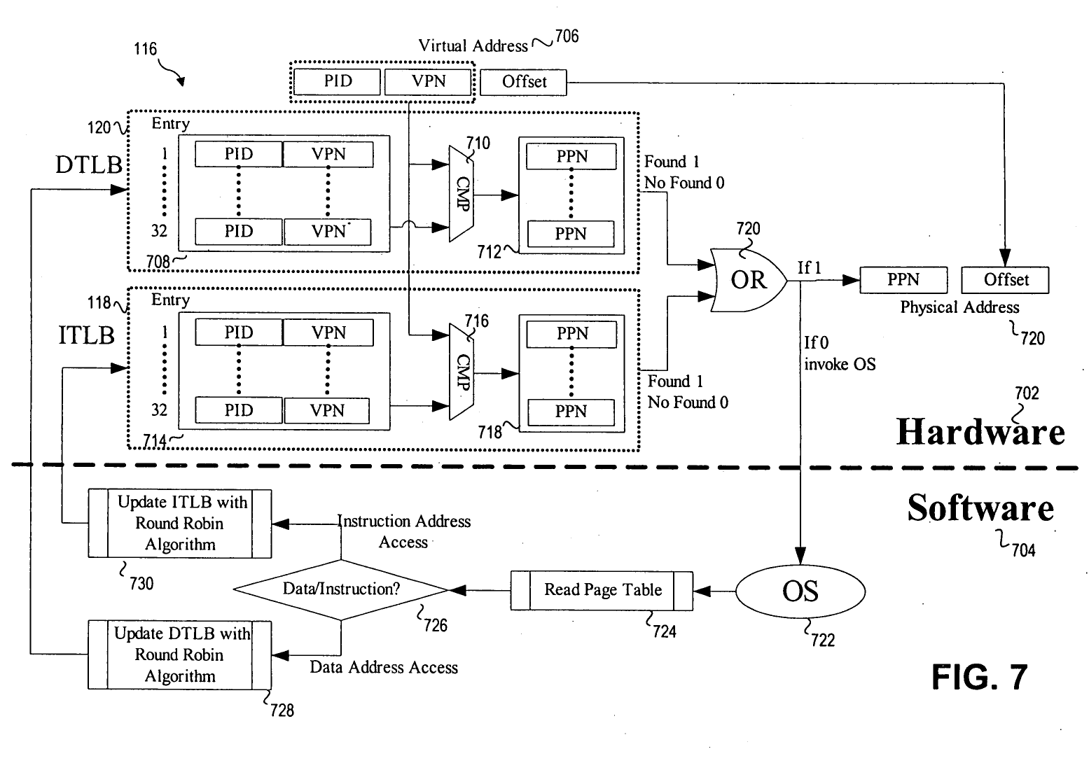

Turning to FIG. 7, an embodiment of the present invention is shown. FIG. 7 shows a computing environment having a hardware layer 702 and a software layer 704. It will be understood that alternative embodiments of hardware layer 702 or software layer 704 may be used to implement a virtual TLB as describe herein.

A virtual address 706 is received at an MMU, such as IMMU 112 or DMMU 114, for translation. Virtual address 706 may include a Process Identifier (PID), Virtual Page Number (VPN), and an Offset. The PID is used to differentiate the memory address space between different processes. The VPN is provided to virtual TLB 116 for lookup.

FIG. 7 also shows an embodiment of DTLB 120 and ITLB 118. DTLB 120 includes 32 TLB entries. Entries shown at 708 include PIDs and VPNs. DTLB 120 also includes entries, shown at 712, storing the Physical Page Numbers (PPNs) corresponding to the PIDs and VPNs at 708. ITLB 118 similarly includes 32 TLB entries. Entries shown at 714 include PlDs and VPNs, and entries shown at 718 include corresponding PPNs. In a TLB lookup, the VPN is compared to the VPNs in DTLB 120 using a Comparator (CMP) 710, and compared to the VPNs in ITLB 118 using CMP 716. If the received VPN is found in either DTLB 120 or ITLB 118, then the corresponding PPN may be identified.

DTLB 120 and ITLB 118 indicate if the received VPN was found in either TLB. If the VPN was found, then the physical address translation of the received virtual address is made by the MMU (DMMU 112 or IMMU 114). If the received VPN is not found in either DTLB 120 or ITLB 118, then a TLB miss is indicated by virtual TLB 116.

As shown in FIG. 7, DTLB 120 and ITLB 118 each provide indicia to an OR-gate 720 indicating if the VPN was found; a logical “1” if the VPN was found, and a logical “0” if the VPN is not found in their respective TLBs. OR-gate 720 outputs a logical “1” if the VPN was found in either DTLB 120 or ITLB 118. In this case, the PPN corresponding to the VPN is combined with the Offset from the virtual address to form a physical address 720.

If neither DTLB 120 nor ITLB 118 have stored the VPN, then OR-gate 720 will output a logical “0” to indicate a TLB miss. The TLB miss will cause OS 722 to initiate a page table read (i.e., lookup), as shown at 724, to find the PPN corresponding to the VPN. After page table read 724, software layer 704 will proceed to a decision block 726.

At decision block 726, the logic determines if the virtual/physical address requested is an instruction address access or a data address access. If the address access is a data address, then the logic proceeds to a block 728 to update DTLB 120 using a round-robin algorithm. If the address access is an instruction address, then the logic proceeds to a block 730 to update ITLB 118 using a round-robin algorithm.

Embodiments of the present invention provide a virtual TLB that includes an ITLB and a DTLB. A TLB lookup for a physical page number corresponding to a given virtual page number may be performed simultaneously at the ITLB and the DTLB. Embodiments of the invention may be implemented on an Intel® XScale™ platform running a MRTE, such as JVM TM, to improve system performance due to fewer TLB misses.

### Embodiments of a Computer System

FIG. 8 illustrates embodiments of a computer system 800 on which embodiments of the present invention may be implemented. Computer system 800 includes a processor 802 and a memory 804 coupled to a chipset 808. Mass storage 812, Non-Volatile Storage (NVS) 806, network interface (I/F) 814, and Input/Output (I/O) device 818 may also be coupled to chipset 808. Embodiments of computer system 800 include, but are not limited to, a desktop computer, a notebook computer, a server, a mobile device, such as a Pocket Personal Computer (PC), a mobile phone, a media player, or the like. In one embodiment, computer system 800 includes processor 802 coupled to memory 804, processor 802 to execute instructions stored in memory 804. Processor 802 may include embodiments of virtual TLB 116 as described herein.

Processor 802 may include, but is not limited to, an Intel® Corporation x86, Pentium®, XScale™ family processor, or the like. In one embodiment, computer system 800 may include multiple processors. In another embodiment, processor 802 may include two or more processor cores.

Memory 804 may include, but is not limited to, Dynamic Random Access Memory (DRAM), Static Random Access Memory (SRAM), Synchronized Dynamic Random Access Memory (SDRAM), or the like. In one embodiment, memory 804 may include one or more memory units that do not have to be refreshed.

Chipset 808 may include a memory controller, such as a Memory Controller Hub (MCH), an input/output controller, such as an Input/Output Controller Hub (ICH), or the like. In an alternative embodiment, a memory controller for memory 804 may reside in the same chip as processor 802. Chipset 808 may also include system clock support, power management support, audio support, graphics support, or the like. In one embodiment, chipset 808 is coupled to a board that includes sockets for processor 802 and memory 804.

Components of computer system 800 may be connected by various interconnects, such as a bus. In one embodiment, an interconnect may be point-to-point between two components, while in other embodiments, an interconnect may connect more than two components. Such interconnects may include a Peripheral Component Interconnect (PCI), such as PCI Express, a System Management bus (SMBUS), a Low Pin Count (LPC) bus, a Serial Peripheral Interface (SPI) bus, an Accelerated Graphics Port (AGP) interface, or the like. I/O device 818 may include a keyboard, a mouse, a display, a printer, a scanner, or the like.

Computer system 800 may interface to external systems through network interface 814 using a wired connection, a wireless connection, or any combination thereof. Network interface 814 may include, but is not limited to, a modem, a Network Interface Card (NIC), or the like. A carrier wave signal 822 may be received/transmitted by network interface 814. In the embodiment illustrated in FIG. 8, carrier wave signal 822 is used to interface computer system 800 with a network 824, such as a Local Area Network (LAN), a Wide Area Network (WAN), the Internet, or any combination thereof. In one embodiment, network 824 is further coupled to a computer system 826 such that computer system 800 and computer system 826 may communicate over network 824.

Computer system 800 may include a wireless communication module. The wireless communication module may employ a Wireless Application Protocol to establish a wireless communication channel. The wireless communication module may implement a wireless networking standard such as Institute of Electrical and Electronics Engineers (IEEE) 802.11 standard, IEEE std. 802.11-1999, published by IEEE in 1999.

Computer system 800 also includes non-volatile storage 806 on which firmware may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like.

Mass storage 812 includes, but is not limited to, a magnetic disk drive, such as a hard disk drive, a magnetic tape drive, an optical disk drive, or the like. It is appreciated that instructions executable by processor 802 may reside in mass storage 812, memory 804, non-volatile storage 806, or may be transmitted or received via network interface 814.

In one embodiment, computer system 800 may execute an Operating System (OS). Embodiments of an OS include Microsoft Windows®, the Apple Macintosh® operating system, the Linux® operating system, the Unix® operating system, or the like.

For the purposes of the specification, a machine-readable medium includes any mechanism that provides (i.e., stores and/or transmits) information in a form readable or readable by a machine (e.g., a computer, network device, personal digital assistant, manufacturing tool, any device with a set of one or more processors, etc.). For example, a machine-readable medium includes, but is not limited to, recordable/non-recordable media (e.g., Read-Only Memory (ROM), Random Access Memory (RAM), magnetic disk storage media, optical storage media, a flash memory device, etc.). In addition, a machine-readable medium may include propagated signals such as electrical, optical, acoustical or other forms of propagated signals (e.g., carrier waves, infrared signals, digital signals, etc.).

Various operations of embodiments of the present invention are described herein. These operations may be implemented using hardware, software, or any combination thereof. These operations may be implemented by a machine using a processor, an Application Specific Integrated Circuit (ASIC), a Field Programmable Gate Array (FPGA), or the like. In one embodiment, one or more of the operations described may constitute instructions stored on a machine-readable medium, that when executed by a machine will cause the machine to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
receiving a virtual page number lookup request at a virtual Translation Lookaside Buffer (TLB), wherein the virtual TLB includes an instruction TLB and a data TLB;
performing a lookup of the virtual page number in the virtual TLB; and
returning a physical page number corresponding to the virtual page number in the virtual TLB.

2. The method of claim 1 wherein performing the lookup of the virtual page number includes performing the lookup of the virtual page number in the instruction TLB and the data TLB simultaneously.

3. The method of claim 1, further comprising performing a page table lookup if the virtual address is not found in the virtual TLB.

4. The method of claim 3, further comprising updating the virtual TLB with the virtual page number and a corresponding physical page number resulting from the page table lookup.

5. The method of claim 4 wherein updating the virtual TLB includes:
updating the data TLB if a physical address corresponding to the virtual address has stored data; and
updating the instruction TLB if the physical address corresponding to the virtual address has stored an instruction.

6. The method of claim 4 wherein the virtual TLB is updated using a round robin algorithm.

7. The method of claim 3 wherein the page table lookup is performed by an operating system.

8. The method of claim 1 wherein the virtual page number lookup request is received from one of a Data Memory Management Unit (DMMU) or an Instruction Memory Management Unit (IMMU).

9. An apparatus, comprising:
a virtual Translation Lookaside Buffer (TLB), the virtual TLB including:
an instruction TLB and a data TLB; and
a TLB lookup logic coupled to the instruction TLB and the data TLB, wherein the TLB lookup logic to lookup a virtual page number in the instruction TLB and the data TLB simultaneously.

10. The apparatus of claim 9 wherein the virtual TLB to return a physical page number corresponding to the virtual page number if the virtual address is found in the instruction TLB or the data TLB.

11. The apparatus of claim 9 wherein the virtual TLB to report a TLB miss if the virtual page number is not found in the instruction TLB or if the virtual page number is not found in the data TLB.

12. The apparatus of claim 9, further comprising a machine-readable medium coupled to the virtual TLB, the machine-readable medium including instructions that, if executed, perform operations comprising:
receiving a TLB miss indicator from the virtual TLB; and
performing a page table lookup using the virtual address.

13. The apparatus of claim 12 wherein the machine-readable medium further includes instructions that, if executed, perform operations comprising:
providing the virtual TLB with the virtual page number and a corresponding physical page number resulting from the page table lookup.

14. The apparatus of claim 13 wherein the machine-readable medium further includes instructions that, if executed, perform operations comprising:
providing the data TLB with the virtual page number and the corresponding physical page number if a physical address corresponding to the virtual address has stored data; and
providing the instruction TLB with the virtual page number and the corresponding physical page number if the physical address corresponding to the virtual address has stored an instruction.

15. The apparatus of claim 13 wherein the virtual TLB is updated using a round robin algorithm.

16. The apparatus of claim 9 wherein the apparatus to execute instructions substantially in compliance with an Advanced RISC (Reduced Instruction Set Computer) Machines (ARM) instruction set.

17. A system, comprising:
a Dynamic Random Access Memory (DRAM) unit; and
a processor coupled to the DRAM unit, the processor including:
a virtual Translation Lookaside Buffer (TLB), the virtual TLB including:
an instruction TLB and a data TLB; and
a TLB lookup logic coupled to the instruction TLB and
the data TLB, wherein the TLB lookup logic to lookup a virtual page number in the instruction TLB and the data TLB simultaneously.

18. The system of claim 17 wherein the virtual TLB to return a physical page number corresponding to the virtual page number if the virtual page number is found in the instruction TLB or the data TLB.

19. The system of claim 17, further comprising a machine-readable medium coupled to the processor, the machine-readable medium including instructions that, if executed by the processor, perform operations comprising:
receiving a TLB miss indicator from the virtual TLB if the virtual page number is not found in the virtual TLB; and
performing a page table lookup in the DRAM unit using the virtual address.

20. The system of claim 19 wherein the machine-readable medium further includes instructions that, if executed by the processor, perform operations comprising:
providing the data TLB with the virtual page number and a corresponding physical page number if a physical address corresponding to the virtual address has stored data; and
providing the instruction TLB with the virtual page number and a corresponding physical page number if the physical address corresponding to the virtual address has stored an instruction.

21. An article of manufacture, comprising:
a machine-readable medium including instructions that, if executed by a machine, cause the machine to perform operations comprising:
receiving a virtual page number lookup request at a virtual Translation Lookaside Buffer (TLB), wherein the virtual TLB includes an instruction TLB and a data TLB;
performing a lookup of the virtual page number in the virtual TLB, wherein performing the lookup of the virtual page number includes performing the lookup of the virtual page number in the instruction TLB and the data TLB simultaneously; and
returning a physical page number corresponding to the virtual page number in the virtual TLB.

22. The article of manufacture of claim 21 wherein the machine-readable medium further includes instructions that, if executed by the machine, cause the machine to perform operations comprising:
performing a page table lookup if the virtual address is not found in the virtual TLB.

23. The article of manufacture of claim 22 wherein the machine-readable medium further includes instructions that, if executed by the machine, cause the machine to perform operations comprising:
updating the virtual TLB with the virtual page number and a corresponding physical page number resulting from the page table lookup.
